(19) United States
(12) Patent Application Publication
(10) Pub. No.: US 2025/0207936 A1
(43) Pub. Date: Jun. 26, 2025

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Takehira OTA, Inazawa-shi (JP); Yu NAGATA, Tokyo (JP); Daisuke TANIZAKI, Okazaki-shi (JP)

(73) Assignee: TOYOTA JIDOSHA KABUSHIKI KAISHA, Toyota-shi (JP)

(21) Appl. No.: 18/792,914

(22) Filed: Aug. 2, 2024

(30) Foreign Application Priority Data
Dec. 26, 2023 (JP) 2023-219998

(51) Int. Cl. G01C 21/36; G01C 21/34

(52) U.S. Cl. CPC G01C 21/3685; G01C 21/3476

(57) ABSTRACT

The information processing device includes a control unit that displays, on a display screen of the navigation device, a congestion state of the congested parking lot when the congested parking lot juxtaposed to a destination set on a display screen of the navigation device in the vehicle is congested, searches for information of a candidate alternative parking lot within a range of a predetermined distance from the destination, and displays on the display screen list information of the alternative parking lot satisfying a predetermined condition among the searched candidates.

### CROSS-REFERENCE TO RELATED APPLICATION

This application claims priority to Japanese Patent Application No. 2023-219998 filed on Dec. 26, 2023, incorporated herein by reference in its entirety.

### BACKGROUND

### 1. Technical Field

The present disclosure relates to an information processing device and an information processing method.

### 2. Description of Related Art

Conventionally, a technique related to searching for parking lot candidates has been known. For example, Japanese Unexamined Patent Application Publication No. 2023-112934 (JP 2023-112934 A) discloses a parking lot proposal system in which, when a user sets a destination, a list of parking lot candidates determined in consideration of history information on a user and a third party is displayed together with a required time, a fee, and parking comfort.

### SUMMARY

However, J P 2023-112934 A does not consider the actual congestion status of parking lots. Therefore, there is a possibility that when a vehicle arrives at a candidate parking lot, the parking lot is fully occupied and cannot be used. In addition, a parking lot in the site of the destination or a parking lot annexed to the destination can be used free of charge on condition of use of the destination facility in many cases, and there is a possibility that a toll parking lot is proposed to cause an economic loss. Thus, there is room for improvement with the technique related to searching for parking lot candidates.

In view of such circumstances, an object of the present disclosure is to improve the technique related to searching for parking lot candidates.

An aspect of the present disclosure provides an information processing device including: a communication unit; and a control unit that performs communication using the communication unit, in which the control unit displays, on a display screen of a navigation device in a vehicle, a congestion state of a parking lot annexed to a destination set on the display screen when the annexed parking lot is congested, make a search for information on alternative parking lot candidates located within a range of a predetermined distance from the destination, and displays information on a list of alternative parking lots that meet a predetermined condition, among the candidates found in the search, on the display screen.

An aspect of the present disclosure provides an information processing method, in which an information processing device executes a process including: displaying, on a display screen of a navigation device in a vehicle, a congestion state of a parking lot annexed to a destination set on the display screen when the annexed parking lot is congested; making a search for alternative parking lot candidates located within a range of a predetermined distance from the destination; and displaying information on a list of alternative parking lots that meet a predetermined condition, among the candidates found in the search, on the display screen.

According to an aspect of the present disclosure, it is possible to improve the technique related to searching for parking lot candidates.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration example of a system according to an embodiment of the present disclosure;

FIG. 2 is a flow chart illustrating an exemplary operation of the information processing device; and

FIG. 3 is a schematic diagram illustrating a display example of the navigation device.

### DETAILED DESCRIPTION OF EMBODIMENTS

Hereinafter, an embodiment of the present disclosure will be described.

### Outline of Embodiment

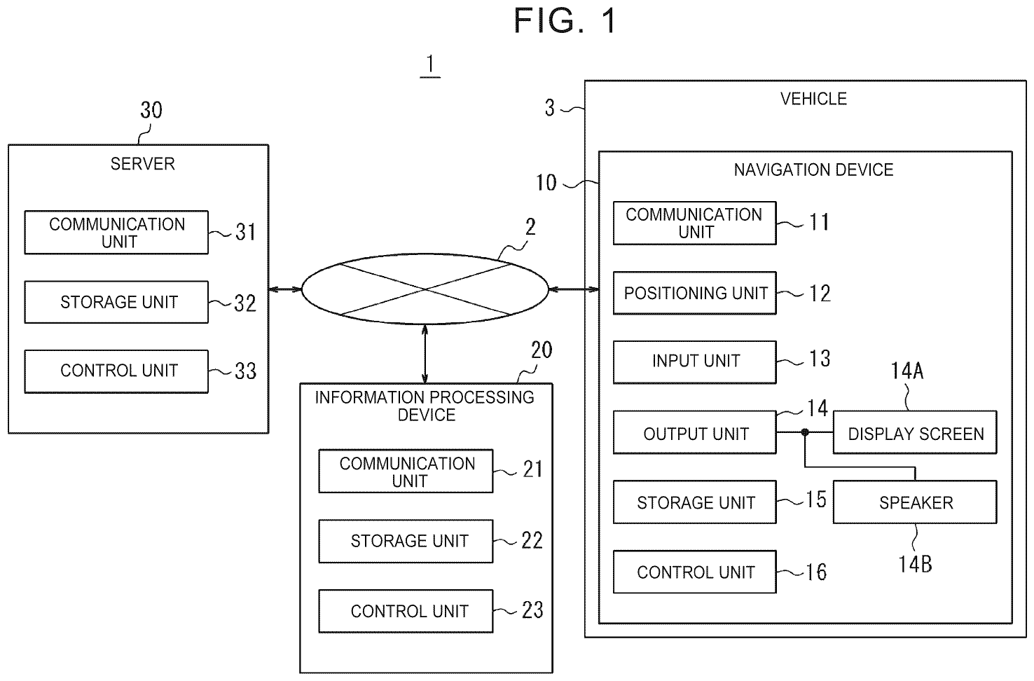

The outline of a system 1 according to an embodiment of the present disclosure will be described with reference to FIG. 1. The system 1 includes a vehicle 3, a navigation device 10, an information processing device 20, and a server 30. The navigation device 10, the information processing device 20, and the server 30 are communicably connected to a network 2 including, for example, the Internet and a mobile communication network.

The vehicle 3 is, for example, an automobile, but is not limited thereto, and may be any vehicle. Vehicles include, but are not limited to, Battery Electric Vehicle (BEV), Hybrid Electric Vehicle (HEV), Plug-in Hybrid Electric Vehicle (PHEV), or Fuel Cell Electric Vehicle (FCEV). The number of vehicles 3 included in the system 1 may be arbitrarily determined.

The navigation device 10 is a car navigation device installed in the vehicle 3. However, the navigation device 10 is not limited to the so-called “car navigation” installed in the dashboard of the vehicle 3. The navigation device 10 may be a so-called “smart phone navigation” in which a smart phone or a tablet terminal carried by a driver of the vehicle 3 is temporarily installed on a dashboard and a car navigation application is executed on a display screen 14A of the terminal. In the present disclosure, “car navigation” is referred to as a car navigation 10A, and “smartphone navigation” is referred to as a smartphone navigation 10B.

The information processing device 20 is, for example, a computer such as a server apparatus. The information processing device 20 can communicate with the navigation device 10 and the server 30 via the network 2.

The server 30 is, for example, a computer such as a server device owned by a business operator that operates a facility serving as a destination or a business operator that operates a service for providing usage information of a parking lot. The server 30 can communicate with the navigation device 10 and the information processing device 20 via the network 2.

First, the outline of the present embodiment will be described, and the details will be described later. The information processing device 20 displays the congestion state of the juxtaposed parking lot on the display screen 14A when the juxtaposed parking lot juxtaposed to the destination set on the display screen 14A of the navigation device 10 in the vehicle is congested, and searches for information of the alternative parking lot candidates within a predetermined distance from the destination, and displays the list information of the alternative parking lots satisfying the predetermined condition among the searched candidates on the display screen 14A.

As described above, according to the present embodiment, in a case where the parking lot at the destination is congested, the list information of the alternative parking lot satisfying the predetermined condition is displayed. For this reason, even in a case where the juxtaposed parking lot cannot be used in a full car, and a fee-based alternative parking lot must be used, the user can select the alternative parking lot under the desired condition from the list information of the alternative parking lot. Therefore, the technique for searching for a parking lot candidate is improved in that the convenience of the parking lot guidance is improved.

Next, each configuration of the system 1 will be described in detail.

### Configuration of the Navigation Device

As illustrated in FIG. 1, the navigation device 10 includes a communication unit 11, a positioning unit 12, an input unit 13, an output unit 14, a storage unit 15, and a control unit 16.

The communication unit 11 includes one or more communication interfaces connected to the network 2. The communication interfaces correspond to mobile communication standards such as 4th Generation (4G) or 5th Generation (5G), for example, but are not limited thereto. In the present embodiment, the navigation device 10 communicates with the information processing device 20 via the communication unit 11 and the network 2.

The positioning unit 12 includes one or more devices that acquire position information of the vehicle 3. Specifically, the positioning unit 12 includes, for example, a receiver corresponding to GPS, but is not limited thereto, and may include a receiver corresponding to any satellite-based positioning system.

The input unit 13 includes at least one input interface capable of accepting an input by the driver of the vehicle 3. The input interface is, for example, a physical key, a capacitive key, a pointing device, a camera, a touch screen integrally provided with a display of an output unit 14 to be described later, a microphone that picks up sound of a driver, or the like. However, the input interface is not limited thereto.

The output unit 14 is configured to include at least one audio output interface capable of outputting audio and at least one display interface capable of displaying text or video. The audio-output interfaces are, for example, speakers (hereinafter, referred to as speaker 14B). The display interface is, for example, a display screen such as an LCD or an organic EL display (hereinafter, referred to as a display screen 14A). The audio output interface and the display interface are not limited thereto.

The storage unit 15 includes one or more memories. The memories are, for example, a semiconductor memory, a magnetic memory, or an optical memory, but are not limited to these memories. Each memory included in the storage unit 15 may function as, for example, a main storage device, an auxiliary storage device, or a cache memory. The storage unit 15 stores arbitrary information used for the operation of the navigation device 10. For example, the storage unit 15 may store a system program, an application program, embedded software, and the like. The information stored in the storage unit 15 may be updatable by, for example, information acquired from the network 2 via the communication unit 11.

The control unit 16 includes one or more processors, one or more programmable circuits, one or more dedicated circuits, or a combination of these. The processor may be, but is not limited to, a general-purpose processor such as, for example, Central Processing Unit (CPU) or Graphics Processing Unit (GPU), or a special-purpose processor specialized for a particular process. The programmable circuitry is, for example, but not limited to, Field-Programmable Gate Array (FPGA). The dedicated circuitry is, for example, but not limited to, Application Specific Integrated Circuit (ASIC). The control unit 16 controls the overall operation of the navigation device 10.

### Configuration of Information Processing Device

As illustrated in FIG. 1, the information processing device 20 includes a communication unit 21, a storage unit 22, and a control unit 23.

The communication unit 21 includes one or more communication interfaces connected to the network 2. The communication interfaces correspond to, for example, a mobile communication standard, a wired Local Area Network (LAN) standard, or a radio LAN standard, but are not limited thereto, and may correspond to any communication standard. In the present embodiment, the information processing device 20 communicates with the navigation device 10 and the server 30 via the communication unit 21 and the network 2.

The storage unit 22 includes one or more memories. Each memory included in the storage unit 22 may function as, for example, a main storage device, an auxiliary storage device, or a cache memory. The storage unit 22 stores any information used for the operation of the information processing device 20. For example, the storage unit 22 may store a system program, an application program, a database, and the like. The information stored in the storage unit 22 may be updatable by, for example, information acquired from the network 2 via the communication unit 21.

The control unit 23 includes one or more processors, one or more programmable circuits, one or more dedicated circuits, or a combination thereof. The control unit 23 controls the operation of the information processing device 20 as a whole.

### Configuration of Server

As illustrated in FIG. 1, the server 30 includes a communication unit 31, a storage unit 32, and a control unit 33.

The communication unit 31 includes one or more communication interfaces connected to the network 2. The communication interfaces correspond to, for example, a mobile communication standard, a wired Local Area Network (LAN) standard, or a radio LAN standard, but are not limited thereto, and may correspond to any communication standard. In the present embodiment, the server 30 communicates with the information processing device 20 via the communication unit 31 and the network 2.

The storage unit 32 includes one or more memories. Each memory included in the storage unit 32 may function as, for example, a main storage device, an auxiliary storage device, or a cache memory. The storage unit 32 stores any information used for the operation of the server 30. For example, the storage unit 32 may store a system program, an application program, a database, and the like. The information stored in the storage unit 32 may be updatable by, for example, information acquired from the network 2 via the communication unit 31.

The control unit 33 includes one or more processors, one or more programmable circuits, one or more dedicated circuits, or a combination thereof. The control unit 33 controls the operation of the entire server 30.

### Operation Flow of Information Processing Device

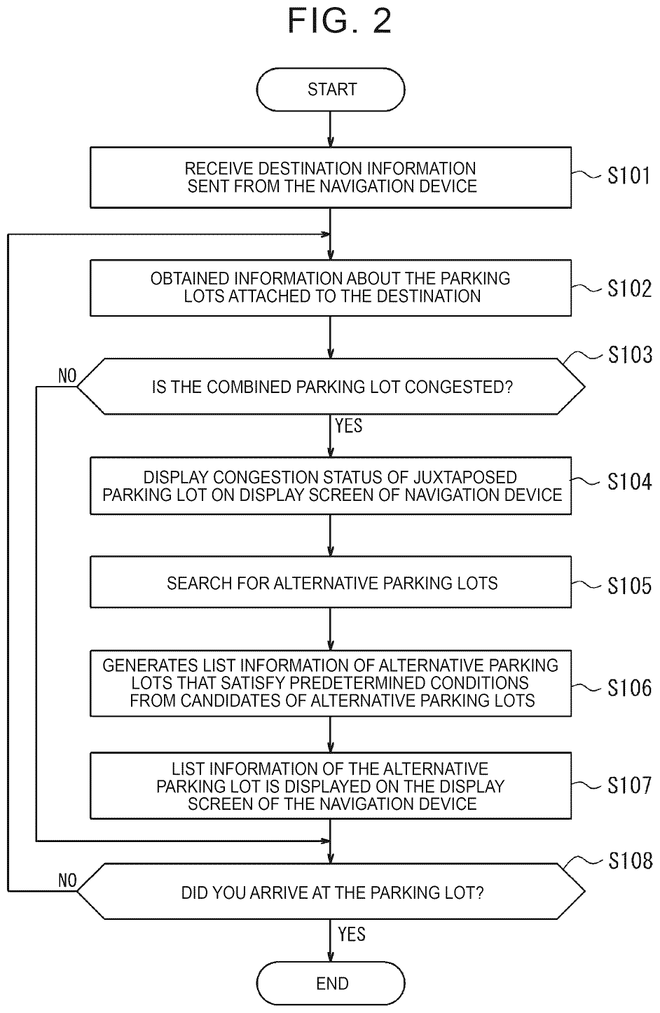

An operation of the information processing device 20 according to the present embodiment will be described with reference to FIG. 2. This operation relates to the display of list information of alternative parking lots that satisfy predetermined conditions.

S101: The control unit 23 receives information of the destination set in the display screen 14A of the navigation device 10 in the vehicle.

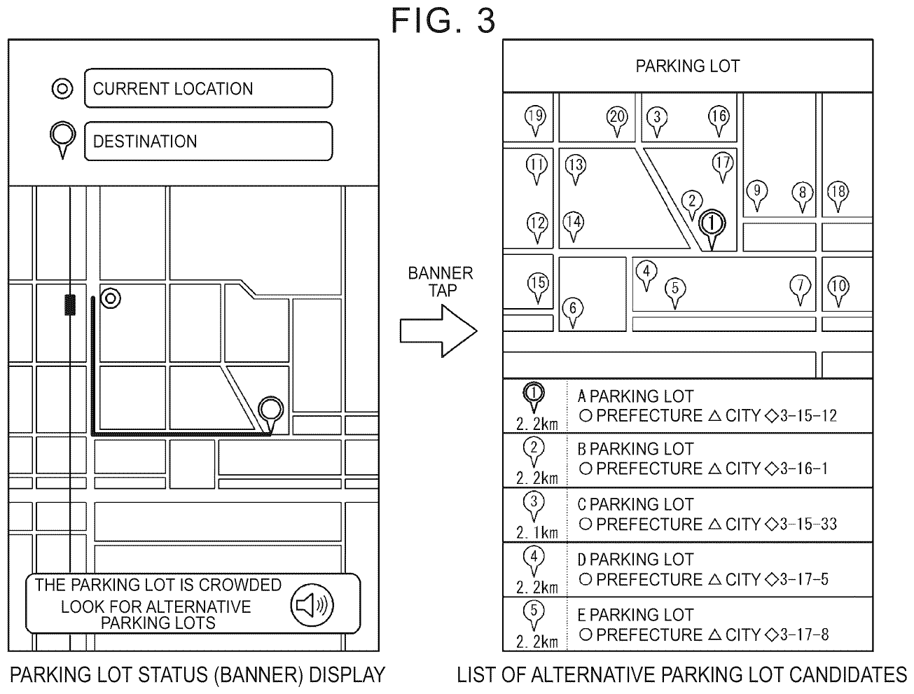

FIG. 3 is a schematic diagram illustrating a display example of the navigation device 10. The destination information is location information of the destination. The position information is information on latitude and longitude of a target point. As illustrated in FIG. 3, when the driver of the vehicle 3 sets the destination on the display screen 14A of the navigation device 10, the position information of the current position of the vehicle 3 positioned by the positioning unit 12 and the position information of the destination are transmitted to the information processing device 20.

S102: The control unit 23 acquires the information of the juxtaposed parking lot juxtaposed to the received destination.

The juxtaposed parking lot is a parking lot for visitors which is juxtaposed to facilities such as a bank, a store, a commercial facility, a school, and a hospital, which are destinations. In many cases, the parking lot is available free of charge on the assumption that the destination facility is used. The information of the juxtaposed parking lot is, for example, a numerical value indicating the occupancy rate of the parking space, but is not limited thereto. For example, in a case where the occupancy rate of the parking space is 100%, the parking lot to be attached is full. For example, the control unit 23 acquires the occupancy rate of the parking space of the juxtaposed parking lot via the communication unit 21 and the network 2 from the server 30 of the business operator that operates the facility serving as the destination or the business operator that operates the provision service of the use information of the parking lot.

S103: The control unit 23 determines whether the juxtaposed parking lot is congested. If the juxtaposed parking lot is crowded, proceed to S104; if not, proceed to S108.

When the occupancy rate of the parking space of the juxtaposed parking lot exceeds a predetermined value, the control unit 23 determines that the juxtaposed parking lot is congested. The predetermined value is, for example, 90%, but is not limited thereto.

S104: The control unit 23 displays the congestion status of the juxtaposed parking lot on the display screen 14A of the navigation device 10.

FIG. 3 is an example of the display screen 14A of a smartphone navigation 10B. As illustrated in FIG. 3, the display of the congestion status is, for example, a banner display on the display screen 14A, but the display is not limited to the banner display. The congestion status may be notified by sound by a speaker 14B of the smartphone navigation 10B.

Further, the control unit 23 may banner the fee information or the state of the construction of the concatenated parking lot on the display screen 14A when the parking fee of the concatenated parking lot of the destination is higher than the normal fee or when a part or all of the concatenated parking lot is under construction at the scheduled date and time when the vehicle 3 arrives at the destination.

S105: The control unit 23 searches for alternative parking lot candidates within a predetermined range from the destination.

The control unit 23 acquires information of the alternative parking lot within a range of a predetermined distance from the destination via the communication unit 21 and the network 2 from the server 30 of the operator that operates the service for providing the use information of the parking lot. The information of the alternative parking lot includes, but is not limited to, the name, address, location information, occupancy rate of the parking space at the search time, and the like of the candidate of the alternative parking lot. As illustrated in FIG. 3, the control unit 23 acquires information on a plurality of candidates of alternative parking lots (20 in the example of FIG. 3) within a predetermined distance from the destination, and displays information on candidates of the plurality of alternative parking lots on a display screen 14A. The control unit 23 may search for an alternative parking lot in which the occupancy rate of the parking space at the search time is equal to or less than a predetermined value (for example, equal to or less than 90%).

As illustrated in FIG. 3, when the driver of the vehicle 3 taps the banner display, the information of the alternative parking lot candidate may be searched for, or the search for the alternative parking lot candidate may be started at a stage when it is determined that the juxtaposed parking lot is congested.

S106: The control unit 23 generates a list of alternative parking lots that satisfy a predetermined criterion among the retrieved alternative parking lot candidates.

The predetermined condition is, for example, that (i) the parking fee per predetermined time (e.g., one hour) is relatively low among the candidates of the alternative parking lot, or that (ii) the total time of the time that the vehicle 3 moves from the departure location to the entrance of the alternative parking lot, the time that the vehicle 3 moves from the entrance of the alternative parking lot to the parking space, and the time that the driver of the vehicle 3 moves by walking from the parking space of the alternative parking lot to the entrance of the destination facility is relatively short among the candidates of the alternative parking lot. However, the predetermined condition is not limited thereto. The condition desired by the driver of the vehicle 3 may be set to a predetermined condition.

S107: The control unit 23 displays a list of the generated alternative parking lots on the display screen 14A of the navigation device 10.

As illustrated in FIG. 3, for example, the control unit 23 displays a predetermined number of candidates for the alternative parking lot on the display screen 14A. In the example of FIG. 3, the predetermined number is 5 from the A parking lot to the E parking lot, but the present disclosure is not limited thereto. When the predetermined condition (i) is satisfied, the control unit 23 displays a list of a predetermined number of alternative parking lots on the display screen 14A in descending order of the parking fee. When the predetermined condition (ii) is satisfied, the control unit 23 displays a list of a predetermined number of alternative parking lots on the display screen 14A in order of the shortest total time.

When the driver of the vehicle 3 selects a desired alternative parking lot (in the example of FIG. 3, the A parking lot) on the display screen 14A, the control unit 16 of the navigation device 10 starts route guidance from the current location to the selected A parking lot.

S108: The control unit 23 determines whether the vehicle 3 has arrived at the selected parking lot. If it has not arrived at the parking lot, the process returns to S102 to continue the information processing, and if it has arrived, the information processing is terminated.

The control unit 23 terminates the information processing when the notification that the vehicle 3 has arrived at the alternative parking lot is acquired from the navigation device 10. On the other hand, when the vehicle 3 has not arrived at the selected alternative parking lot, the control unit 23 returns to S102 and continues the information processing. The control unit 23 performs information processing in accordance with a change in the situation when the juxtaposed parking lot becomes available due to a change in the situation or when the alternative parking lot desired by the driver of the vehicle 3 is changed.

As described above, the information processing device 20 according to the present embodiment displays the congestion status of the juxtaposed parking lot on the display screen 14A when the juxtaposed parking lot juxtaposed to the destination set on the display screen 14A of the navigation device 10 in the vehicle is congested, searches for information on the alternative parking lot candidate that is within a predetermined distance from the destination, and displays on the display screen 14A the list information of the alternative parking lot that satisfies the predetermined condition among the searched candidates.

According to such a configuration, in a case where the parking lot at the destination is congested, the list information of the alternative parking lot satisfying the predetermined condition is displayed. For this reason, even in a case where the juxtaposed parking lot cannot be used in a full car, and a fee-based alternative parking lot must be used, the user can select the alternative parking lot under the desired condition from the list information of the alternative parking lot. Therefore, the technique for searching for a parking lot candidate is improved in that the convenience of the parking lot guidance is improved.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the information processing device 20 may be distributed among a plurality of computers capable of communicating with each other. Further, for example, an embodiment in which some or all of the components of the information processing device 20 are provided in the navigation device 10 is also possible. For example, the navigation device 10 mounted on the vehicle 3 may include some or all of the components of the information processing device 20.

Further, an embodiment is also possible in which, for example, a general-purpose computer functions as the information processing device 20 according to the above embodiment. Specifically, a program describing processing contents for realizing each function of the information processing device 20 according to the above embodiment is stored in the memory of the general-purpose computer, and the program is read out and executed by the processor. Therefore, the present disclosure can also be realized as a program that can be executed by the processor or a non-transitory computer-readable medium that stores the program.

What is claimed is:

1. An information processing device comprising:
a communication unit; and
a control unit that performs communication using the communication unit, wherein the control unit displays, on a display screen of a navigation device in a vehicle, a congestion state of a parking lot annexed to a destination set on the display screen when the annexed parking lot is congested, make a search for information on alternative parking lot candidates located within a range of a predetermined distance from the destination, and displays information on a list of alternative parking lots that meet a predetermined condition, among the candidates found in the search, on the display screen.

2. The information processing device according to claim 1, wherein the control unit further displays, on the display screen of the navigation device, fee information on the annexed parking lot, or a status of construction work, when a parking fee of the annexed parking lot is higher than a fee for normal times, or when a part or all of the annexed parking lot is under construction, at a date and time when the vehicle is expected to arrive at the destination.

3. The information processing device according to claim 1, wherein:
the predetermined condition is that a parking fee per predetermined time is relatively low among the alternative parking lot candidates; and
the control unit displays information on a list of a predetermined number of alternative parking lots on the display screen in an ascending order of the parking fee.

4. The information processing device according to claim 1, wherein:
the predetermined condition is that a total time of a time during which the vehicle moves from a departure location to an entrance of an alternative parking lot, a time during which the vehicle moves from the entrance of the alternative parking lot to a parking space, and a time during which a driver of the vehicle moves on foot from the parking space to an entrance of a destination facility is relatively short among the alternative parking lot candidates; and
the control unit displays information on a list of a predetermined number of alternative parking lots on the display screen in an ascending order of the total time.

5. An information processing method, wherein an information processing device executes
displaying, on a display screen of a navigation device in a vehicle, a congestion state of a parking lot annexed to a destination set on the display screen when the annexed parking lot is congested,
making a search for alternative parking lot candidates located within a range of a predetermined distance from the destination, and
displaying information on a list of alternative parking lots that meet a predetermined condition, among the candidates found in the search, on the display screen.
